(19) United States
(12) Patent Application Publication
(10) Pub. No.: US 2026/0014908 A1
(43) Pub. Date: Jan. 15, 2026

(54) MULTI-WAY LUMBAR SUPPORT SYSTEM

(71) Applicant: LEAR CORPORATION, Southfield, MI (US)

(72) Inventors: Peter OEBERG, Mullsjo (SE); Daniel JOSEFSSON, Mullsjo (SE)

(73) Assignee: LEAR CORPORATION, Southfield, MI (US)

(21) Appl. No.: 18/996,394

(22) PCT Filed: Jul. 29, 2023
(86) PCT No.: PCT/US2023/029051

§ 371 Date: Jan. 17, 2025

Related U.S. Application Data
(60) Provisional application No. 63/393,631, filed on Jul. 29, 2022.
(60) Provisional application No. 63/431,701, filed on Dec. 11, 2022.

(51) Int. Cl. B60N 2/66; B60N 2/90

(52) U.S. Cl. CPC B60N 2/665; B60N 2/914; B60N 2/976

(57) ABSTRACT

A support system for a seat includes a suspension coupled to the frame of a seatback. A plurality of pneumatic cells are coupled to the suspension. Each pneumatic cell is expandable and independently controllable to expand between a first position and a second position. A flexible reaction surface covers a forward surface of the plurality of air cells and the reaction plate maintains a smooth transition surface when each of the plurality of pneumatic cells is expanded to the first and second positions.

### CROSS-REFERENCE TO RELATED APPLICATIONS

This application claims the benefit of U.S. provisional application Ser. No. 63/393,631 filed Jul. 29, 2022 and U.S. provisional application Ser. No. 63/431,701 filed Dec. 11, 2022, the disclosures of which are hereby incorporated in their entirety by reference herein.

### BRIEF DESCRIPTION OF THE DRAWINGS

FIG. 1 illustrates a front view of a seat with a portion of the lumbar support system according to one embodiment.

FIG. 2 illustrates a schematic side view of a seat with a lumbar support system.

FIG. 3 illustrates a schematic side view of a seat with a lumbar support system according to one embodiment.

FIG. 4 illustrates a schematic side view of a seat with a lumbar support system according to one embodiment.

FIG. 5 illustrates a front view of a lumbar support system according to one embodiment.

FIG. 6 illustrates a front view of a lumbar support system according to another embodiment.

FIG. 7 illustrates a front view of a portion of a lumbar support system with the front reaction plate removed.

FIG. 8 illustrates a bottom view of a lumbar support system according to one embodiment.

FIG. 8 illustrates a plurality of functions of a lumbar support system according to at least one embodiment.

FIG. 9 illustrates a valve configuration according to one embodiment.

FIG. 10 illustrates a front view of a seat with a lumbar support system according to one embodiment.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if”' is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

According to one embodiment, a support system for a seat has a suspension coupled to the frame of a seatback. A plurality of pneumatic cells are coupled to the suspension, each pneumatic cell expandable and independently controllable to expand between a first position and a second position. A flexible reaction surface covers a forward surface of the plurality of air cells and the reaction plate maintains a smooth transition surface between each of the pneumatic cells.

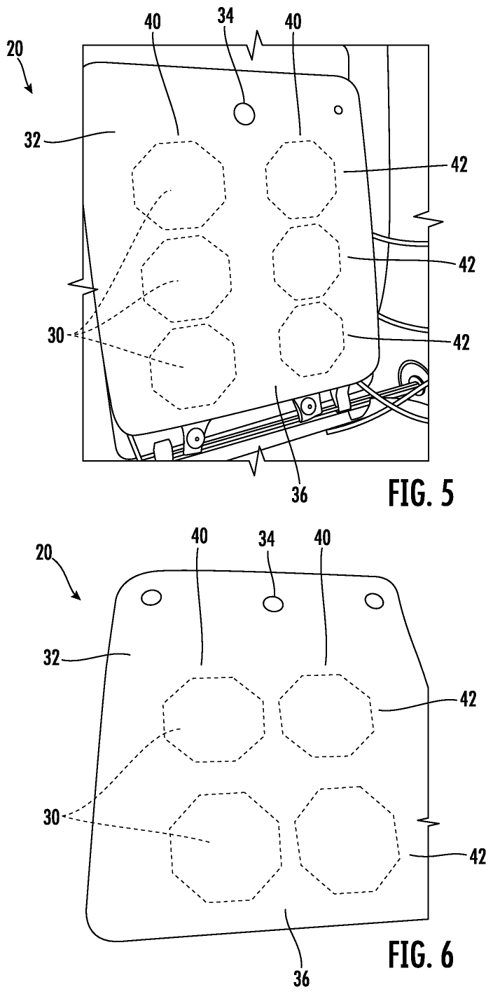

FIG. 1 illustrates a seat 10 having a lumbar support system 20. The lumbar support system 20 has a suspension board 22 coupled to a frame 24 of a seatback 26. The lumbar support system has plurality small pneumatic cells 30 coupled to the support. Each pneumatic cell 30 is expandable and independently controllable to expand to provide increasing support as the pneumatic cells expand between. A flexible reaction plate 32 (FIGS. 5-6) covers a forward surface of the plurality of pneumatic cells 30. The reaction plate 32 provides a reaction surface that maintains a smooth transition surface that bridges between each of the pneumatic cells 30. The lumbar support system 20 uses smaller pneumatic cells 20 than prior pneumatic lumber systems that increased response because the smaller volume cells can inflate and deflate quickly. The reaction plate 32 that covers the pneumatic cells provides a comfortable contoured support to the user.

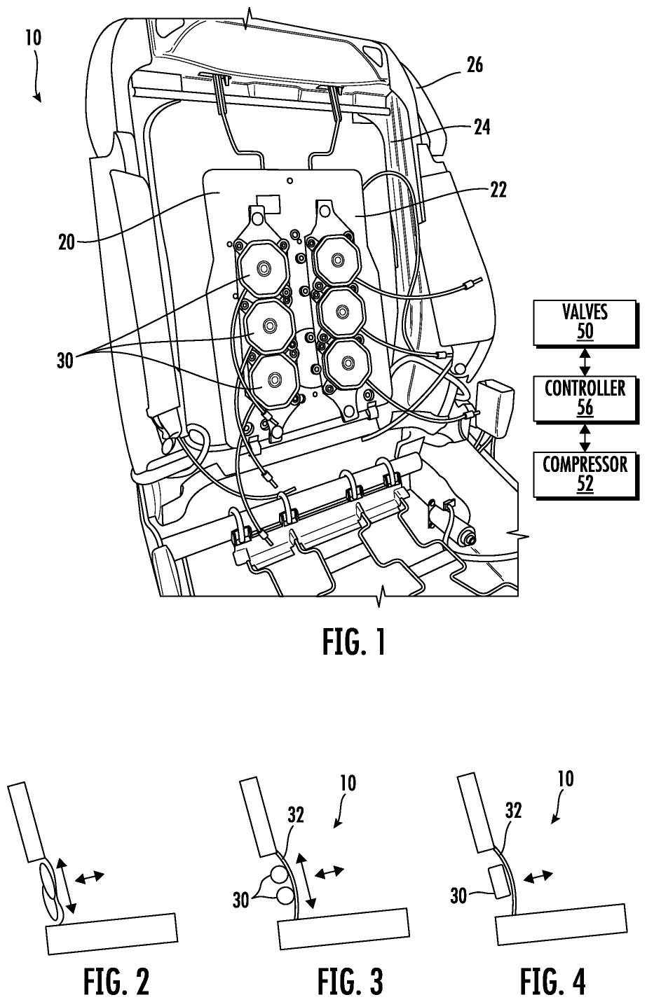

As shown in FIG. 2, prior traditional 4-way pneumatic lumber systems use two air cells, lower and upper. These systems create gaps and uneven support surfaces that may be uncomfortable.

As shown in FIGS. 3-4, the lumbar support system 20 of the present application has the reaction plate 32 that maintains the smooth transition surface being a convex contour between each of the pneumatic cells 30 and a smooth transition of lumbar apex adjustment. The reaction plate 32 may be formed of fiber needle felt, resin or plastic, high density foam or any other material that can provide a curvature under the load of the pneumatic cells expanding. The reaction plate 32 may be 0.5 mm to 2 mm thick. For example, the reaction plate 32 is flexible enough to provide a curvature height equal to one to six times the height of lumbar cells. In another embodiment, the reaction plate 32 is flexible enough to provide a curvature height equal to 1.5 to four times the height of lumbar cells. The reaction plate 32 between pneumatic cells also enables using small lumbar pneumatic cells 30. The reaction plate 32 and smaller pneumatic cells 30 also allows a rapidly responding lumbar function. The lumbar support system 20 may be used in 4-way systems, like in FIG. 3, or more simple 2-way systems, like in FIG. 4 For example, a traditional pneumatic 2-way lumbar system may have a pneumatic bladder having a volume of up to one-liter. In contrast, the lumber system in FIG. 4 may have two small air cells of 100 ml or even less, while still providing a curvature that is comfortable. This would improve the fill time from 12-18 seconds down to 4-6 seconds.

The pneumatic cells 30 may also be covered directly by a firm padding layer that defines the padding or cushioning of the seatback. The firm padding layer covers a forward surface of the pneumatic cells. The firm padding layer provides the reaction surface that maintains a smooth transition surface that bridges between each of the pneumatic cells 30.

The pneumatic cells 30 work directly against the padding layer. A level of firmness in the padding layer helps bridge the distance between each of the pneumatic cells 30, preventing the punctual feeling that would occur if a soft layer would be applied on top of the lumbar cells. The padding layer has a firmness to provide lumbar support from the two (or more) cells in each row being inflated.

The padding layer may be formed of foam, flexair, nonfoam or any other material that defines the padding or cushioning of the seatback. Very soft foams would compress in the direction of occupant, 2-4 kPa, and just exhibit a local pressure point similar to the cell size. A firmer foam would allow bridging the gap between cells, and thereby providing the “lumbar curvature” both across and vertically. In one embodiment, the padding layer may have a firmness of 5-7 kPa hardness, or firmer. The padding layer may be a firm foam to provide enough support to “bridge” the gap between the air cells too. In another embodiment, the firm padding layer may be a needle felt that is adhered to the B-side of the seat back cushion foam. The needle felt may have a density of 200 g/m², for example. Other materials like a ventilation spacer can also be enough to reinforce the foam and provide enough firmness to form a reaction surface that bridges between the pneumatic cells.

In other embodiments, such as dual hardness foam options, the important aspect is the reaction surface that the pneumatic cells are working against is of sufficient firmness to act as bridging material for the multi-zone lumbar solution. If the foam is too soft and too compressible, the foam cannot provide enough support to generate a lumbar function and would not minimize pressure points. In a typical embodiment, the lumbar reaction surface would be a firm seat foam, optionally a felt reinforced softer seat foam, or foam of dual/gradient hardness.

The segmented pneumatic cells 30 have a minimum of two individual zones, that can operate independent left and right lumbar stroke. The pneumatic cells 30 may also be arranged to have additional zones allowing for massage and rotation or torso/lumber region in four directions, that is left, right, up and down (Y and Z directions).

Further, by splitting in a minimum two channels, left and right side can be separately controlled, in combination with a 2-way lumbar. With further channels the function can be better defined with a 4-way lumbar, or even as a three or six zone lumbar where six control channels are used.

The present application includes an additional segmentation that provides left and right adjustment, in addition to upper and lower adjustment of the lumbar region. By allowing adjustment of the left and right area individually the lumbar support system 20, offers torso “rotation” feature on top of a normal lumbar massage feature.

The lumbar support system 20 provides an enhancement of body fit functionality, with a way of minimizing pressure for twisted seat positions, as well as a “mini” swivel support for conversation turned seating for passengers, or even egress support.

As shown in FIGS. 5-6, the reaction plate 32 is only coupled to the suspension board 22 adjacent one edge and an opposite edge is free and not coupled to the support board 22. The reaction plate 32 is coupled to the support adjacent an upper edge 34. The reaction plate 32 is only coupled to the suspension board 22 adjacent the upper edge and a lower edge 36 is free. FIG. 5 illustrates a lumbar support system 20 with six pneumatic cells 30 positioned between the reaction plate 32 and the frame. FIG. 6 illustrates a lumbar support system 20 with four pneumatic cells 30. Other configurations or numbers of small pneumatic cells 30 may be used.

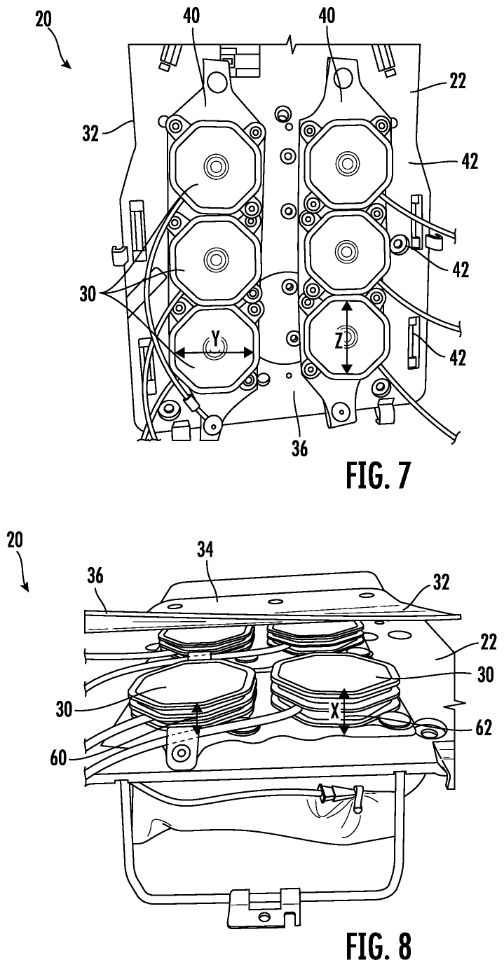

The lumbar support system 20 uses a plurality of pneumatic cells 30 that are smaller in size than typical lumbar supports, as shown in the FIGS. 7-8 having a width Y, a height Z and an expandable depth X. For example, each pneumatic cell 30 may have a width Y being generally 60 millimeters (mm) and a height Z being generally 40 mm. In another embodiment, each pneumatic cell 30 may have a width Y and height Z that is generally equal. In another embodiment, the width Y and height Z may be in the range of 20-120 mm. In one embodiment, each pneumatic cell 30 may be independently controlled to expand a depth X being 30 mm. In another embodiment, each pneumatic cell 30 may expand a depth X in the range of 0-100 mm. Other sized and shaped pneumatic cells may be used.

Traditional 2-way lumbar assemblies have a large pneumatic bladder having surface coverage with a height Z of 250 mm and a width Y from 170-200 mm. A fast response small cell can reduce the lumbar air cell coverage to 80×60 mm or less, and use the reaction plate to distribute pressure appropriately.

The pneumatic cells 30 may be spaced apart in a lateral direction and a vertical direction while the flexible reaction plate 32 ensures a smooth transition between the cells. For example, the plurality of pneumatic cells 30 are spaced apart in the lateral direction and the vertical direction by at least 50% of a corresponding lateral width or vertical height of the pneumatic cells. In another embodiment, the pneumatic cells may be spaced apart by up to 200 mm. Other spacing or configurations may be used.

The lumbar support system 20 may have at least two pneumatic cells 30. The pneumatic cells 30 may be spaced apart in the upright direction or the lateral direction. In another embodiment shown in FIG. 6, the lumbar support system 20 has at least four pneumatic cells 30 spaced apart in both the lateral direction and the upright direction. In another embodiment as shown in FIG. 1, the lumbar support system 20 has at least six pneumatic cells 30.

As shown in the Figures, the pneumatic cells 30 may be arranged to have at least two upright rows 40 of pneumatic cells 30 extending in the upright direction and spaced apart in the lateral direction. The pneumatic cells 30 may also be arranged to have at least two lateral rows 42 of pneumatic cells 30 extending in the lateral direction and spaced apart in the upright direction. As shown in FIG. 1, the lumbar support system has two upright rows 40 and three lateral rows 42 of pneumatic cells 30. The plurality of pneumatic cells 30 may be arranged in other suitable configurations for providing moving lumbar support with massage and/or rotation functionality.

The lumbar support system 20 also may have a valve bank 50 in communication with the plurality of pneumatic cells 30 and compressor 52 for providing air to the pneumatic cells 30. A controller 56 may be in communication with the valve bank 50 and programed to control expansion of the pneumatic cells 30.

The controller 56 may command a first portion of the pneumatic cells 30 to expand and command a second portion of the pneumatic cells 30 to compress to a depth less than the first portion.

The controller 56 may also receive inputs and/or commands from a user, sensors or other controllers. If the controller 56 receives a command indicating an occupant rotation request, the controller 56 may command a first portion, such as a first upright row 40, to expand to a first depth 60, and command a second portion, such as a second upright row 40 to expand to a second depth 62 greater than the first depth 60, as shown in FIG. 8, for example.

The rotation request may be based on an indication the occupant is exiting the seat. Alternatively, the rotation request may be based on a vehicle motion, or input indicating the occupant is in a twisted/rotated seating position.

The controller 56 may also receive a command indicating a massage request. If the controller 56 receives a command indicating a massage request, the controller 56 may command a first portion, such as a first lateral row 42, to expand to a first depth, and command a second portion, such as a second lateral row 42 to expand to a second depth greater 62 than the first depth 60.

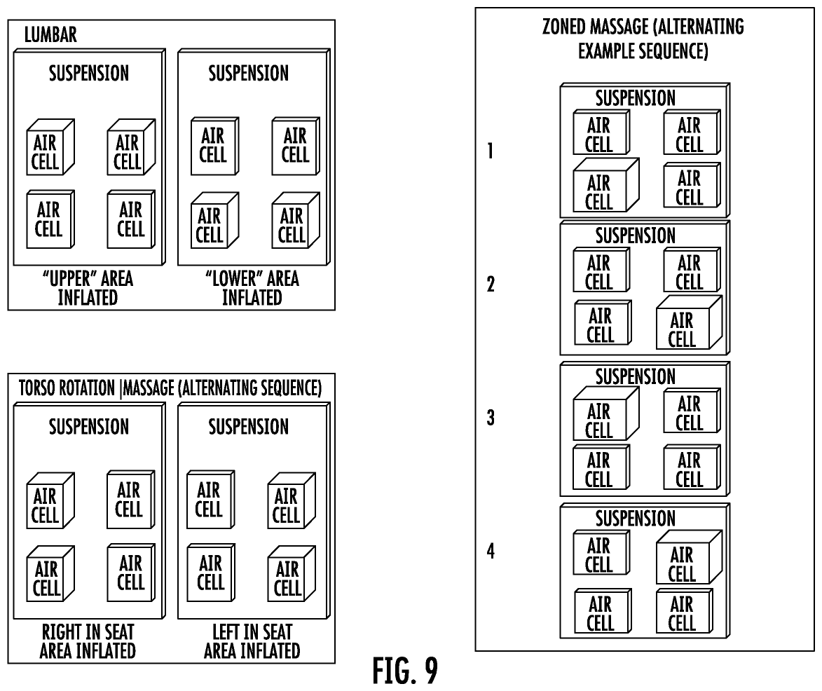

Common designs of a lumbar cell covering the full cross area of the occupant cannot provide a torso rotation, nor a segmented massage function without adding additional air cells and valves. FIG. 9 illustrates a plurality of functions of a lumbar support system according to at least one embodiment. The function achieved is the combination lumbar support, torso rotation or torso rotation massage, traditional up down lumbar massage and four (or more) punctual massage, starting from four pneumatic functions. In a preferred embodiment the four (or more) pneumatic functions are controlled by an inflate port per each function and a common deflate port, allowing individual function control with a minimal valve content. Another embodiment can be with a regular 2/2 valve configuration connected to each pneumatic function in the system.

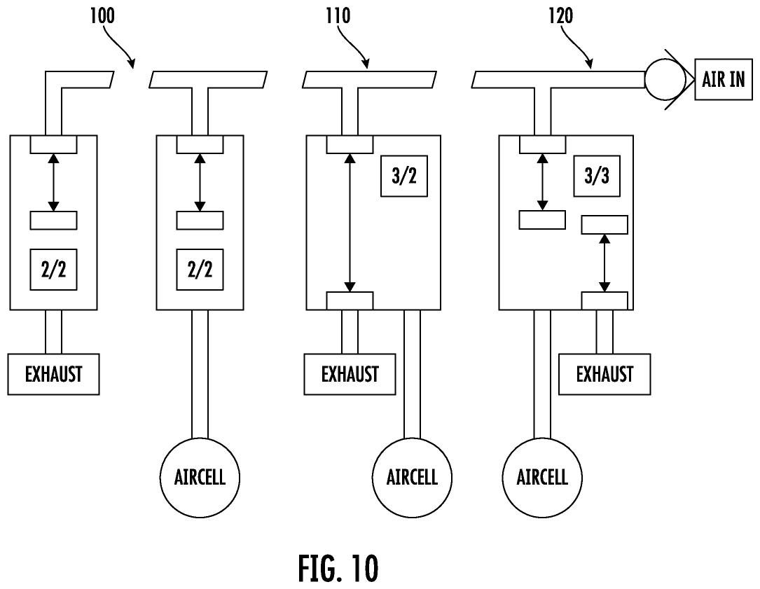

FIG. 10 illustrates various valve configurations that may be used with the system. In valve configuration 100, a 2/2 valve configuration is illustrated. The 2/2 valve configuration 100 has two air ports and two actuator positions. As such, the valve configuration 100 can be actuated to inflate or deflate.

In valve configuration 110, a 3/2 valve configuration is illustrated. The 3/2 valve configuration 110 has three air ports and two actuator positions. This valve configuration 110 permanently deflates and may be use with systems normally not needing to hold pressure.

In valve configuration 100, a 3/3 valve configuration is illustrated. The 3/3 valve configuration 120 has three air ports and three actuator positions. The 3/3 valve configuration 120 allows each pneumatic function can be inflated and deflated independently of the rest of the system.

For valve count optimization, 2/2 valve configuration 100 can be used to simplify the valve, but may limit control since only one function, such as inflate or deflate, can be actuated at a time.

Applying a multi-zone lumbar with massage options with 6 functions, valving can be simplified using six modules of 2/2 valve configurations 100 for inflate and one module for deflate control. Compared to a traditional system where at least four 3/3 valves and two 3/2 valves would be applied to achieve the same functionality.

Most current massage systems use 3/2 valve configuration 110 or 3/3 valve configuration 120.

Item 1: According to an embodiment, the present disclosure provides support system for a seat comprising a suspension coupled to the frame of a seatback. A plurality of pneumatic cells are coupled to the suspension. Each pneumatic cell is expandable and independently controllable to expand between a first position and a second position. A flexible reaction surface covers a forward surface of the plurality of air cells and the reaction plate maintains a smooth transition surface when each of the plurality of pneumatic cells is expanded to the first and second positions.

Item 2: In another embodiment, the present disclosure provides the support system of Item 1, wherein the reaction surface maintains the smooth transition surface being a convex contour between each of the pneumatic cells.

Item 3: In another embodiment, the present disclosure provides the support system of Item 1 wherein the reaction surface maintains the smooth transition surface from an apex defined by at least one of the pneumatic cells and another of the pneumatic cells.

Item 4: In another embodiment, the present disclosure provides the support system of Item 1 to 2, wherein the reaction surface comprises a comfort layer of the seatback.

Item 5: In another embodiment, the present disclosure provides the support system of Item 1 to 2, wherein the comfort layer comprises at least one of a firm foam, flex-air, a soft foam reinforced with felt, a dual-hardness foam or a gradient-hardness foam.

Item 6: In another embodiment, the present disclosure provides the support system of Item 1 to 2, wherein the reaction surface comprises a reaction plate coupled to the suspension adjacent an upper edge.

Item 7: In another embodiment, the present disclosure provides the support system of Item 1 to 6, wherein the reaction plate is coupled to the suspension only adjacent the upper edge and a lower edge is free.

Item 8: In another embodiment, the present disclosure provides the support system of Item 1 to 7, wherein the reaction plate is coupled to the suspension only adjacent one edge and an opposite edge is free and not coupled to the suspension.

Item 9: In another embodiment, the present disclosure provides the support system of Item 1 to 8, wherein the plurality of pneumatic cells are spaced apart in a lateral direction and a vertical direction.

Item 10: In another embodiment, the present disclosure provides the support system of Item 1 to 9, wherein each of the plurality of pneumatic cells is spaced apart in the lateral direction and the vertical direction by at least 50% of a corresponding lateral width or vertical height of the pneumatic cell.

Item 11: In another embodiment, the present disclosure provides the support system of Item 1 to 10, wherein the plurality of pneumatic cells comprises at least two pneumatic cells.

Item 12: In another embodiment, the present disclosure provides the support system of Item 1 to 11, wherein the plurality of pneumatic cells comprises at least four pneumatic cells.

Item 13: In another embodiment, the present disclosure provides the support system of Item 1to 12, wherein the plurality of pneumatic cells comprises at least six pneumatic cells.

Item 14: In another embodiment, the present disclosure provides the support system of Item 1 to 13, wherein the plurality of pneumatic cells comprises at least two upright rows of pneumatic cells extending in the upright direction and spaced apart in a lateral direction.

Item 15: In another embodiment, the present disclosure provides the support system of Item 1 to 14, wherein the plurality of pneumatic cells comprises at least two lateral rows of pneumatic cells extending in the lateral direction and spaced apart in the upright direction.

Item 16: In another embodiment, the present disclosure provides the support system of Item 1 to 15, further comprising a valve bank in communication with the plurality of pneumatic cells and a controller in communication with the valve bank. The control is programed to command a first portion of the pneumatic cells to expand and command a second portion of the pneumatic cells to expand to a depth less than the first portion. The flexible reaction surface maintains the smooth transition surface between the first portion and the second portion.

Item 17: In another embodiment, the present disclosure provides the support system of Item 1 to 16, wherein the controller is further programed to receive a command indicating an occupant rotation request. The first portion comprises a first row of pneumatic cells extending in the upright direction, and the second portion comprises a second row of pneumatic cells extending in the upright direction and spaced apart from the first row in a lateral direction, wherein the first row is expanded based on the rotation request.

Item 18: In another embodiment, the present disclosure provides the support system of Item 1 to 17, wherein the rotation request is based on an indication the occupant is exiting the seat.

Item 19: In another embodiment, the present disclosure provides the support system of Item 1 to 18, wherein the rotation request is based on a vehicle motion.

Item 20: In another embodiment, the present disclosure provides the support system of Item 1 to 19, wherein the rotation request is based on a detect occupant seating position.

Item 21: In another embodiment, the present disclosure provides the support system of Item 1 to 20, wherein the controller is further programed to receive a command indicating a massage request. The first portion and the second portion are spaced apart in at least the upright direction. The first portion is expanded based on the massage request.

Item 24: In another embodiment, the present disclosure provides the support system of Item 1 to 21, wherein the controller is configured to command the first and second portions of pneumatic cells to perform a plurality of functions.

Item 23: In another embodiment, the present disclosure provides the support system of Item 1 to 24, wherein the valve bank comprises one inflate port for each of the plurality of functions and a common deflate port for the plurality of functions.

Item 24: In another embodiment, the present disclosure provides the support system of Item 1 to 25, wherein the plurality of functions comprises at least four functions comprising torso rotation, lumbar support, rotation massage and up-down massage.

Item 25: In another embodiment, the present disclosure provides a seatback with a seatback frame. The support system of Item 1 is mounted to the seatback frame.

Item 26: In another embodiment, the present disclosure provides the vehicle seat of Item 25, wherein the plurality of pneumatic cells are positioned in a lumbar region of the seatback.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

1. A support system for a seat, the system comprising:
a suspension coupled to a frame of a seatback;
a plurality of pneumatic cells coupled to the suspension, each pneumatic cell expandable and independently controllable to expand between a first position and a second position; and
a flexible reaction surface covering a forward surface of the plurality of pneumatic cells, wherein the reaction plate maintains a smooth transition surface between each of the pneumatic cells when each of the plurality of pneumatic cells is expanded to the first and second positions.

2. The support system of claim 1, wherein the reaction surface maintains the smooth transition surface being a convex contour between each of the pneumatic cells.

3. The support system of claim 1, wherein the reaction surface maintains the smooth transition surface from an apex defined by at least one of the pneumatic cells and another of the pneumatic cells.

4. (canceled)

5. The support system of claim 4, wherein the reaction surface comprises a comfort layer of the seatback wherein the comfort layer comprises at least one of a firm foam, flex-air, a soft foam reinforced with felt, a dual-hardness foam or a gradient-hardness foam.

6. The support system of claim 1, wherein the reaction surface comprises a reaction plate only coupled to the suspension adjacent an upper edge.

7. The support system of claim 6, wherein the reaction plate is only coupled to the suspension adjacent the upper edge-and a lower edge is free.

8. The support system of claim 6, wherein the reaction plate is only coupled to the suspension adjacent one edge and an opposite edge is free and not coupled to the suspension.

9. The support system of claim 1, wherein the plurality of pneumatic cells are spaced apart in a lateral direction and a vertical an upright direction.

10.-14. (canceled)

15. The support system of claim 2, wherein the plurality of pneumatic cells comprises at least two lateral rows of pneumatic cells extending in the lateral direction and spaced apart in the upright direction and the plurality of pneumatic cells comprises at least two upright rows of pneumatic cells extending in an upright direction and spaced apart in a lateral direction.

16. The support system of claim 1, further comprising:
a valve bank in communication with the plurality of pneumatic cells;
a controller in communication with the valve bank and programed to:
command a first portion of the pneumatic cells to expand;
command a second portion of the pneumatic cells to expand to a depth less than the first portion,
wherein the flexible reaction surface maintains the smooth transition surface between the first portion and the second portion.

17. The support system of claim 16, wherein the controller is further programed to:
receive a command indicating an occupant rotation request;
wherein the first portion comprises a first row of pneumatic cells extending in the an upright direction, and the second portion comprises a second row of pneumatic cells extending in the upright direction and spaced apart from the first row in a lateral direction, wherein the first row is expanded based on the rotation request.

18. The support system of claim 17, wherein the rotation request is based on an indication the occupant is exiting the seat.

19. The support system of claim 17, wherein the rotation request is based on a vehicle motion.

20. The support system of claim 17, wherein the rotation request is based on a detect occupant seating position.

21. The support system of claim 16, wherein the controller is further programed to:
receive a command indicating a massage request,
wherein the first portion and the second portion are spaced apart in at least the upright direction, and
wherein the first portion is expanded based on the massage request.

22. The support system of claim 16, wherein the controller is configured to command the first and second portions of pneumatic cells to perform a plurality of functions.

23. The support system of claim 16, wherein the valve bank comprises:
one inflate port for each of the plurality of functions; and
a common deflate port for the plurality of functions.

24. The support system of claim 22, wherein the plurality of functions comprises at least four functions comprising torso rotation, lumbar support, rotation massage and up-down massage.

25. A vehicle seat comprising:
a seatback with a seatback frame; and
the support system of claim 1 mounted to the seatback frame.

26. The vehicle seat of claim 25, wherein the plurality of pneumatic cells are positioned in a lumbar region of the seatback.
